(19) United States
(12) Patent Application Publication
(10) Pub. No.: US 2008/0101456 A1
(43) Pub. Date: May 1, 2008

(54) METHOD FOR INSERTION AND OVERLAY OF MEDIA CONTENT UPON AN UNDERLYING VISUAL MEDIA

(75) Inventors: Justin Ridge, Irving, TX (US); Mark Kokes, Irving, TX (US); Asad Islam, Richardson, TX (US); Ye-Kui Wang, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/622,418

(22) Filed: Jan. 11, 2007

Related U.S. Application Data
(60) Provisional application No. 60/758,110, filed on Jan. 11, 2006.

(51) Int. Cl. H04N 11/02

(52) U.S. Cl. 375/240.01

(57) ABSTRACT

An improved system and method for enabling the insertion, overlay, removal or replacement of sequential or concurrent targeted program segments and/or visual icons in a video bitstream without modifying the fidelity of the underlying visual media. The present invention provides for a wide variety of supplemental enhancement information fields which permit the use of data updates that are synchronous with delivered video content. The present invention offers a generic approach to program insertion and iconic overlay that covers a wide range of use-cases and applications, without necessarily transmitting the visual content to be inserted as part of the underlying visual media stream.

### FIELD OF THE INVENTION

The present invention relates to the fields of video coding, visual media mixing and the editing of visual content. More particularly, the present invention relates to the insertion and/or overlay, removal and replacement of targeted visual content within or upon an underlying visual media.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In the current realization of the H.264/Advanced Video Coding (AVC) standard and its scaleable extension (i.e., scalable video coding (SVC)) there does not exist a generic mechanism that enables the insertion or overlay of targeted visual content. Typically, once a visual source is encoded, it is not modified. It should be understood that, although text and examples contained herein may specifically describe an encoding process, one skilled in the art would readily understand that the same concepts and principles also apply to the corresponding decoding process and vice versa. The addition of graphical overlays, animations and inserted sequential or concurrent program segments have only been possible by decoding the video sequence, rendering the overlay or program segment to be inserted, positioning the content to be added (either spatially or temporally) and then re-encoding the composite sequence. This is a complex and expensive process that can cause fidelity loss (i.e., degradation of picture quality) as well as possible loss of embedded content (i.e. metadata or watermarks).

Previous visual media insertion systems were based entirely on analog video. Programs were distributed as analog video signals with cue-tones present in the program stream to designate program available insertion intervals (i.e. sequential in time). These cues were used to notify authorized content providers where to temporally add, remove or replace program segments with targeted visual content. With the advent of digitally compressed video, these mechanisms are being updated to sufficiently address new video delivery environments, such as cellular, IP, and DVB-H environments. A set of digital program insertion interfaces have been standardized by the Society of Cable Telecommunications Engineers (SCTE) to supplement existing analog/hybrid insertion systems leveraging programs streams. The SCTE 35 standard is used for the insertion of digital cue-tones into a given program stream at the point of service origin (uplink). This solution only addresses the insertion of targeted program content between the temporal endpoints of sequential program segments in a broadcast environment. In the context of compressed digital video delivery, these mechanisms still lack the flexibility to enable a unified mechanism to randomly insert and/or overlay time-varying, targeted visual content into or upon an underlying visual media. As a consequence, these mechanisms do not fully support temporally or spatially triggered applications.

Recent technology advances have made it possible to create concurrent graphical overlays in the compressed domain by implementing selective decode/re-encode of macro-blocks coincident with an overlay boundary. These technologies utilize the notion of “keys” and “fills” to define the content of an overlay and how it is to appear as a composite with the underlying visual media. “Keying” is used to describe the process of inserting visual content with a variable transparency over an existing visual media. The “key” file represents the area of the background visual media into which content is inserted or overlayed and thus defines the outline of the visual content to be inserted. The “fill” file represents the actual content to be inserted. Another way to understand such a system is to consider the “key” as a mask or alpha channel that defines what portion of the “fill” will appear visible at a given level of opacity/transparency as a composite with the underlying visual media.

Although recent technological advances have been made in the area of iconic overlays for video, these methods remain complex and expensive by requiring some combination of selective decoding/re-encoding of the underlying visual content. Such actions impair picture quality, as well as contribute to losses of embedded content such as metadata or watermarks (although the “fill” and “key” methods discussed above may not pose such drawbacks). Furthermore, although the Synchronized Multimedia Integration Language (SMIL) and Lightweight Application Scene Representation (LASeR) systems can realize complete insertion and overlay operations, both systems are quite complex and expensive to implement.

### SUMMARY OF THE INVENTION

The present invention provides a general solution to the problem of enabling the insertion, overlay, removal or replacement of sequential or concurrent targeted program segments and/or visual icons in a video bitstream without modifying the fidelity of the underlying visual media.

The system and method of the present invention offers a generic approach to program insertion and iconic overlay that covers a wide range of use-cases and applications, without necessarily transmitting the visual content to be inserted as part of the underlying visual media stream. However, the method of the present invention does not preclude the transmission of the visual content to be added within the SEI message. It is known that transmitting additional content within the context of the video bitstream can significantly complicate the architecture necessary to sufficiently interpret and decode such added data. The method of the present invention allows for greater flexibility in spatial and temporal placement of inserted visual content, and allows for both sequential and concurrent (i.e. multi-planar) insertions and/or overlays. The present invention can be implemented directly in software using any common programming language, e.g. C/C++ or assembly language, etc.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of an image in which region of interest (ROI) editing and zooming features are implemented;

FIG. 2 shows a series of images in which still image advertisements and/or commercial content is inset in to the images;

FIG. 3 shows an inset image/video overview of a sporting field in a larger image showing in-game action, providing a user with added context in terms of background content;

FIG. 4 shows a series of screen images including an animated video cue for anticipating context of an impending event;

FIG. 5 shows a series of screen images including a visual cue for impending or ongoing graphic content, enabling potential parental control;

FIG. 6(a) is a screen show showing a region of interest graphical overlay; FIG. 6(b) is a screen show showing region of interest editing for surveillance; and FIG. 6(c) is a screen show showing a toning action for a portion of the base image;

FIG. 7 shows how image-filtering effects can be added to image or videos in accordance with the principles of the present invention;

FIG. 8 is a depiction of how scrolling text can be used in conjunction with a video clip for applications such as to depict local time information, stock quotations, and news updates.

FIG. 9 is a depiction of how scrolling text can be added to a video clip for use applications such as distance learning applications or multi-site conferencing.

FIG. 10 is an overview diagram of a system within which the present invention may be implemented;

FIG. 11 is a perspective view of a mobile telephone that can be used in the implementation of the present invention; and

FIG. 12 is a schematic representation of the telephone circuitry of the mobile telephone of FIG. 11.

### DETAILED DESCRIPTION OF THE PREFERRED EMBODIMENTS

The present invention involves the creation of a Supplemental Enhancement Information (SEI) message (within the context of H.264/AVC and SVC) to specifically control and manage the insertion and/or overlay of multi-planar visual content within or upon an underlying visual media, without necessarily including the coded program segment to be inserted or the compressed overlay itself within the SEI message. Within H.264/AVC and SVC, SEI messages provide a data delivery mechanism, allowing data updates synchronous with delivered video content. These messages can be used to assist in processes related to the decoding and rendering of visual content. It should be noted that the bitstream to be decoded can be received from a remote device located within virtually any type of network. Additionally, the bitstream can be received from local hardware or software. In the present invention, a new SEI message type is introduced to simplify visual rendering, mixing and editing. SEI messages are not required by the decoder for the reconstruction of luma or chroma samples of the underlying visual content. Consequently, decoders are not required to process SEI information to be conformant with the H.264/AVC or SVC specifications.

The present invention can use a wide variety of potential SEI message fields for successful implementation thereof. A number of potential message fields are discussed below. However, it should be noted that fields other than those discussed below may also be used.

Source ID. A source ID can allow for tracking multiple insertion and/or overlay instances (i.e. multi-planar layering). The ID can also be used to imply the order of processing or prioritization (i.e., left to right, top to bottom, etc.) of the insertions and/or overlays for the current frame to be rendered.

Sequential/Concurrent Indicator. A sequential/concurrent indicator can be used to specify the manner in which an insertion and/or overlay is to occur in the bitstream. For example, “sequential” may indicate a temporal methodology, wile “concurrent” might indicate a spatial methodology.

Source Type Indicator. A source type indicator can be used to specify the type of insertion or overlay, be it compressed or uncompressed graphic (e.g. ARGB, SVG), image (e.g. RGB, PNG, GIF and potentially JPG or any other image format not supporting transparency), video (e.g. YUV, MPEG-1, MPEG-2, MPEG-4, H.263, H.264, Real Video and WMV) or an undefined (i.e. blank) reservation indicator. Numerous types of sources can be referenced in this field.

Source Format Indicator. A source format indicator can be used to specify the format of an insertion and/or overlay. Such an indicator would most often be used in the case of uncompressed graphic, image or video data. There are currently at least 40 commonly known uncompressed or packed image/video formats that may be referenced in this field.

Rendering Window Width. A rendering window width field may represent the width of the window into which the inserted visual media frame is to be rendered.

Rendering Window Height. A rendering window height field may represent the height of the window into which the inserted visual media frame is to be rendered.

Rendering Window Spatial X-Axis Offset. A rendering window spatial X-axis offset field, relative to the upper left-hand corner of the underlying visual media, can be used to indicating the X-axis pixel location at which the upper left-hand corner of the insertion and/or overlay is to be rendered.

Rendering Window Spatial Y-Axis Offset. A rendering window spatial Y-axis offset relative to the upper left-hand corner of the underlying visual media can be used to indicate the Y-axis pixel location at which the upper left-hand corner of the insertion and/or overlay is to be rendered.

Timestamp Relative to Time Placement of the SEI Message in the Program Stream. This timestamp indicates the rendering start time of the corresponding insertion and/or overlay. Such a timestamp can allow for pre-roll or queuing of visual content to be added.

Duration Indicator. A duration indicator can represent the length of time in which to render the corresponding insertion and/or overlay. Such a duration indicator can allow for a range of values from zero (i.e., indicating an OFF-state) to an indefinite value (i.e., always ON). Units of such an indicator can comprise, for example, micro-seconds.

Fill Source Pointer. A “fill” source pointer can indicate an address or URL capable of providing specific pieces of visual content or access to a visual content server from which to obtain media for filling a program available segment and/or overlay.

Key Source Pointer. A “key” source pointer can indicate an address or URL capable of providing specific pieces of visual content (i.e. visual masks) or access to a visual content server from which to acquire media for keying a program available segment and/or overlay. If the key source pointer assumes a value of null (invalid), then the mask may not physically be present. If the key source pointer has a value of zero, the mask might then be provided via an auxiliary coded picture. Any other value or specific address may indicate an external source. In the case of an alpha blending process, the samples of an auxiliary coded picture can be interpreted as indications of the degree of opacity or, along the same lines, the degrees of transparency associated with the corresponding luma samples of the primary coded picture with which it is associated. The transmitted “key” in this case represents both the color and logical AND mask necessary to perform the keying operation on a per-pixel selection.

Region of Interest (ROI) Width. A ROI width field can represent the width of a region of interest within the “fill” or “key” source frame. The ROI can be used to zoom or crop a corresponding “fill” or “key” frame. The resulting ROI is applied to the rendering window.

ROI height. ROI height field can represent the height of a region of interest within the “fill” or “key” source frame. The ROI can be used to zoom or crop a corresponding “fill” or “key” frame. The resulting ROI is applied to the rendering window.

ROI Window Spatial X-Axis Offset. A ROI window spatial X-axis offset relative to the upper left-hand corner of the corresponding “fill” or “key” frame can indicate the X-axis placement of the upper left-hand corner of the ROI window within the corresponding “fill” or “key” frame.

ROI Window Spatial Y-Axis Offset. A ROI window spatial Y-axis offset relative to the upper left-hand corner of the corresponding “fill” or “key” frame can indicate the Y-axis placement of the upper left-hand corner of the ROI window within the corresponding “fill” or “key” frame.

ROI Application Indicator. A ROI application indictor can specify the manner in which the ROI is applied to the rendering window. It can be left in its original state/location, it can be scaled to fit the rendering window, or it can be applied in a user-defined manner.

Color Blend Type. A color blend type can indicate the color blending method to use. There are at least seven possible color blending operations: 1) no color blending, 2) color blend with constant alpha, 3) color blend with per pixel alpha, 4) alternate color blend, 5) color blend logical AND, 6) color blend logical OR, 7) color blend logical INVERT.

Color Blend Constant. A color blend constant indicator can be used to perform the arithmetic blending operation per color channel. This is particularly useful when color blend type is designated as “blend with constant alpha”. If color blend per pixel alpha is NOT in effect, this value can be used to point to a per-pixel alpha mask or indicate the use of an aux coded picture as a blending mask.

Plane Blend Depth. A plane blend depth field can be used to blend multiple sources into a single destination. The plane depth can be specified such that lower numbers are on top of planes with higher numbers. Plane blend depth can be used in conjunction with source ID to set blend priority or layering characteristics. The blending of planes with the same depth is undefined.

Plane Blend Alpha. A plane blend alpha field indicates the alpha value to be used when blending planes. This alpha is used only when planes do not have the same depth (or related source ID).

Dither Type. A dither type field can indicate how to perform a color format conversion between two sources with differing color format precision. The dithering type could specify at least four of the most common alternatives: 1) no dithering, 2) ordered dithering, 3) error diffusion dithering, and 4) “other dithering method” to allow any number of other user-defined mechanisms.

Effect Indicator. An effect indicator can be used to specify any number of possible visual enhancements. There are currently at least sixty common transitional effects used in typical visual presentations and editing scenarios. The temporal location of the effect varies and can be inherent to the effect (i.e. count-down at start of a visual sequence or a transition effect) or time-specific (i.e. at the beginning, ending or in the middle of a visual sequence). The effect indicator is more likely to be used for common features like changing colors, size, orientation, etc. of overlays to indicate a temporal or spatial event.

Each of the enumerated fields in the SEI messages indicated above enable particular features, spanning a wide variety of use-cases and applications. A number of such use-cases and applications are detailed as follows.

Interactivity and visual sciences compliment each other on a regular basis. There are currently a number of applications of interactive visual content in the marketplace. Any methodology simplifying these scenarios will have an impact on the manner in which this content is served to the consumer.

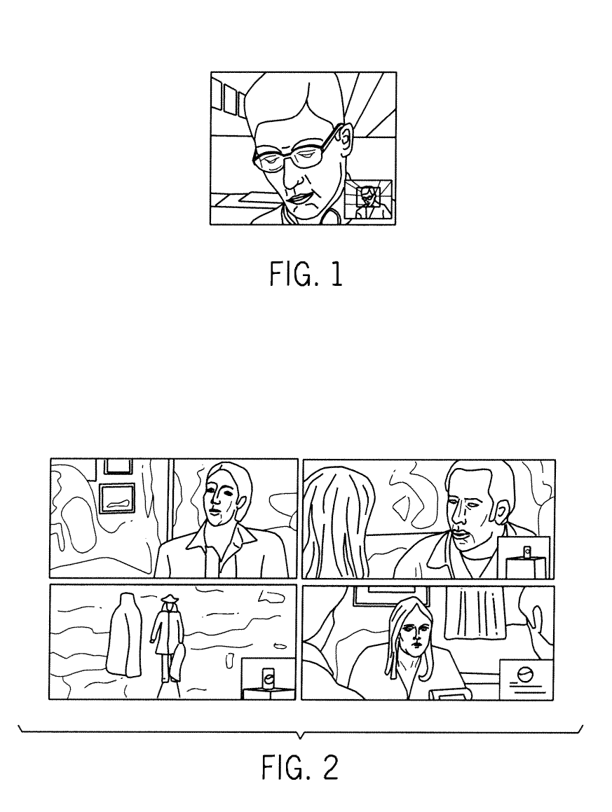

The present invention enables features such as the ability to zoom in or out using ROI indicators. Such a zooming feature is depicted in FIG. 1. The present invention also provides the ability to render interactive messages on the fly as an overlay, whether for a single billboard or in a community environment (such as a video commentary billboard). Furthermore, the present invention provides for the rendering navigational aids for real-time decision-making. Such a feature can be used in an automotive scenario. For example, a live camera feed in a vehicle can be overlayed with a 3D map on a heads-up display. Such a feature can also be used for providing voting or requests for personal information targeted at fantasy sports, national talent showcases or reality television series. Other mapping-related or location-based features could motivate such an interactive mapping overlay capability.

The insetting graphics, images and video content between or upon program segments has numerous use-cases, a number of which are discussed as follows. Logo insertion is a traditional added value in the video transport chain. A logo can take on various semantic meanings and can provide valuable information necessary to the consumer. Authentication, ownership, classification, discrimination and encryption are just a few of the many other possible use-cases. The SEI message may include the logo itself, or it may include a pointer (such as a URL) to the location of a logo. In one embodiment, the SEI message indicates the logo type (such as still image, animated image, or video sequence) and, optionally, the file format for the logo. In another embodiment, the spatial location within the video frame at which the logo is to be inserted is included in the SEI message. In a further embodiment, timing information, such as whether the logo is to appear indefinitely or whether it should disappear after a particular time interval, is included in the SEI message. In still another embodiment, transition information, such as whether the opacity of the logo is to increase or decrease (leading to a “fade in” or “fade out” effect) is included in the SEI message. In yet another embodiment, translational information is specified in the SEI message, permitting the logo to be moved within the frame (such as from the left side to the right side of the frame) at a particular rate.

Targeted commercials, such as localized advertisement content, can be added to video at intermediate points in the program distribution process, with the ability to be stripped or added at each re-transmission node or even at the point of consumption by a consumer's home networking or mobile device. The program segments can be added between indicated program segments or over the top of already existing program segments. FIG. 2 shows a video with such a advertisement having been added to the lower right hand corner of the video. In one embodiment, default content (such as a national advertisement) is encoded into the video bit stream, and an indicator (such as an SEI message) indicates a “blank” overlay. The indicator may optionally specify the location, dimensions, or duration of the overlay. The blank overlay may be replaced by targeted content (such as advertisements localized to a particular geographic region or particular demographic, for example, males aged 25-30 living in the southern United States who hunt). In a further embodiment, the targeted content used to replace the blank overlay is viewer-dependant. The selection of content for a particular viewer may be based on information already known by the entity inserting the content (such as information directly submitted by the viewer, or previous viewing or purchasing patterns), or retrieved dynamically during video transmission (such as the characteristics of the device being used by the viewer, or how long they have been watching a broadcast).

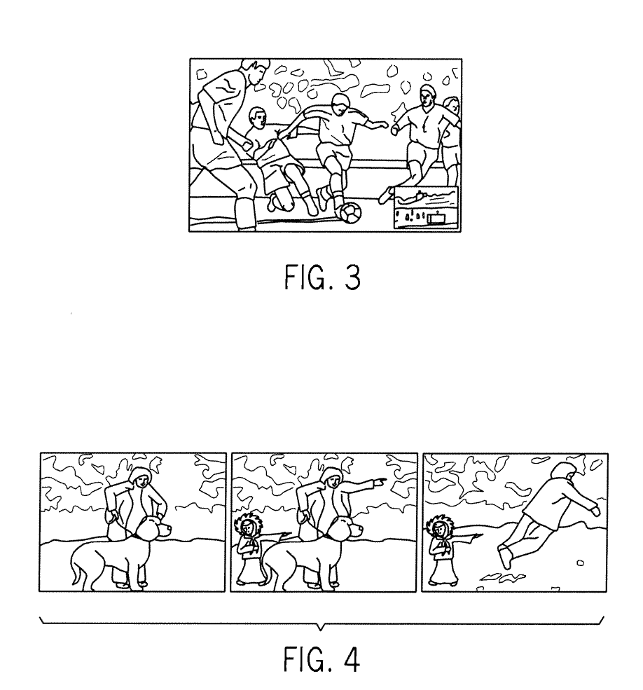

As a mechanism of strong DRM, logos can easily be inserted or overlayed. Seals can be added for authentication or watermarking. Emblems or object tags can be inserted, indicating ownership, production/distribution, or origin anywhere in the distribution path for any object occurring in the visual sequence. In such a situation, the overlay or insertion may simply be temporary and later removed after re-branding, successful delivery or distribution, entertainment rights change, or any other number of possible business or technical-related scenarios. Sponsorship information or scene tags can be added for classification of content to be used later for search purposes. In such an embodiment, advertisers might sponsor particularly dramatic or relevant scenes, sequences or stills. This is particularly useful in the case of video pod-casting. Slide presentation can be inserted or overlayed in order to address distance learning use-cases. In another embodiment of distance learning, recommended class notes can be overlayed and/or camera views or other class participants can be overlayed on a question-by-question basis. Customized arrangement and viewing of multi-party conferencing participants can be expressed in a dynamic fashion. As shown in FIG. 3, scene overviews can be added for sports and other use cases. Transparency in general can be addressed with overlay masks to enable augmented reality or full on virtual reality when combined with 3D graphics. Such an embodiment has relevant consequences in the service industries and in the construction industries (i.e. overlay of plumbing, electrical, cable and networking components in a real-life, real-time environment). In the graphics scenario mentioned above, such a feature could be used to enhance the scalable vector graphic and imagery/video interactions, providing additional inherent rendering clues to OpenVG, OpenGL ES and EGL. Picture-in-picture scenarios are easily addressed as well with the present invention.

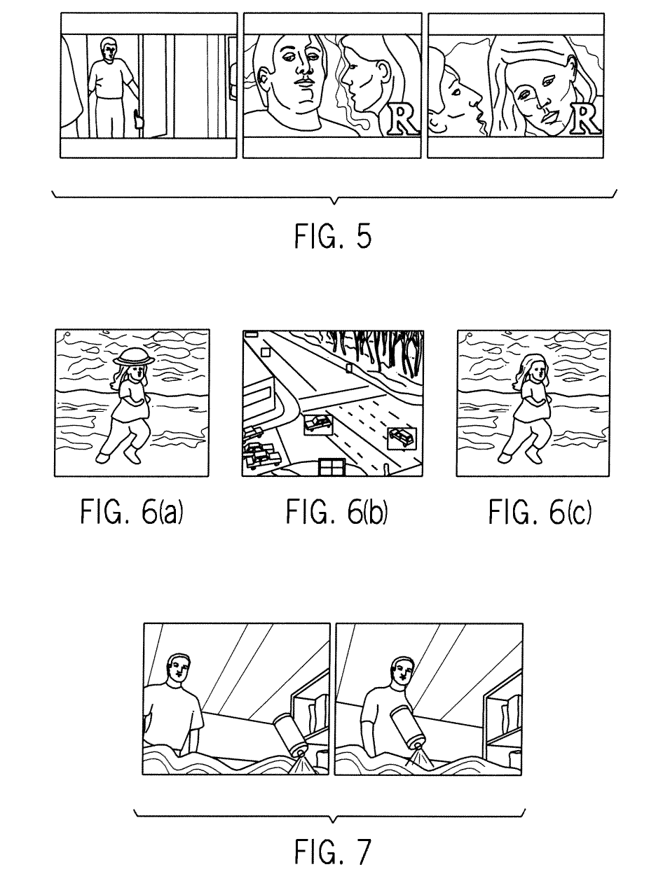

Visual cues related to particular still images, scenes or entire visual sequences can be used as markers of temporal or spatial events, often to convey a mood, emotion, anticipation, foreshadowing and numerous other senses. One example of such a use is depicted in FIG. 4. Similarly, parental and/or general content control, privacy indicators (such as no DRM rights available to copy or record a particular program segment), security indicators, indications of links to visual content within metadata or hidden keys can also be added to images, scenes or visual sequences. In addition, “discrimination” information can be used during a video sequences for purposes such as to specify impending graphic or other content that may be age sensitive. Such information is depicted in FIG. 5, where potentially age-sensitive scenes are identified. Furthermore, consumer electronics based applications for still image and video camera control can implement these features. Indicators are prevalent in numerous consumer electronic cameras and mobile telephones for dictating, for example, the number of pictures taken or remaining, white balance level, flash control, level of exposure or shooting mode, contrast and brightness control and focus adjustment.

Numerous editing and visual mixing features can also be served with the present invention. These features may include, but are not limited to, the editing of scenes and region of interests, generic graphical overlays (as shown, for example, in FIG. 6(a)), animation, surveillance and tracking of visual objects in a scene or sequence (as depicted in FIG. 6(b)), military applications such as target acquisition and marking, cropping of a visual frame, toning (as shown in FIG. 6(c)), image filtering effects (depicted in FIG. 7) and the application of transitional effects.

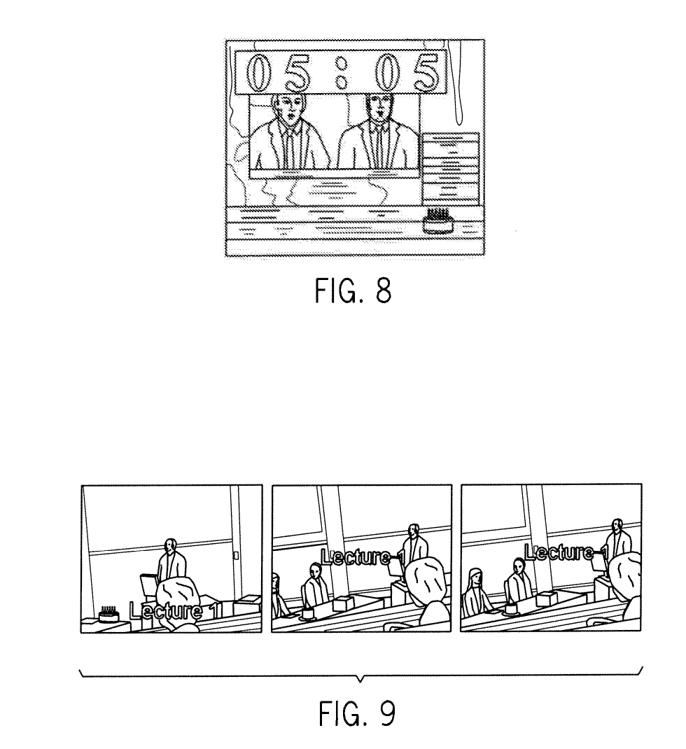

There are also numerous applications for using informational tickers and animated text. Many of these applications relate to providing the consumer sports scores, regional weather and inclement weather-related alerts, local time and temperature, stock tickers (as depicted in FIG. 8) and associated world times. Other applications relate to the exhibition of Amber alerts referencing missing children, regional alerts pertaining to natural or man-made emergencies, news headlines, directions as they relate to the visual content being consumed (i.e., travel tips or directions, cooking instructions and/or ingredients, etc.), scrolling text for automated text-to-speech or book-on-tape/CD, class room lecture notes (as depicted in FIG. 9, for example) or providing statistics related to the underlying visual content.

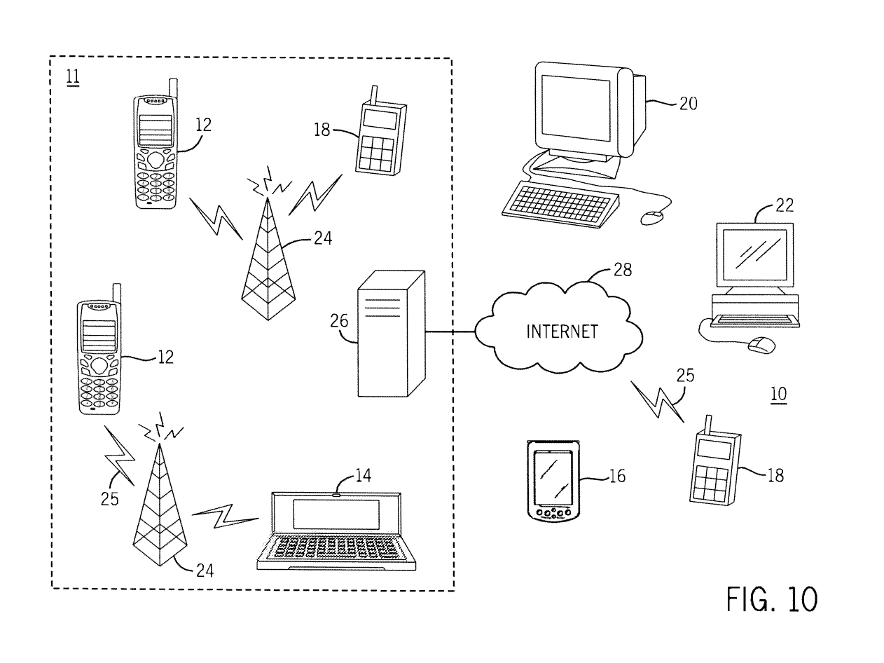

FIG. 10 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

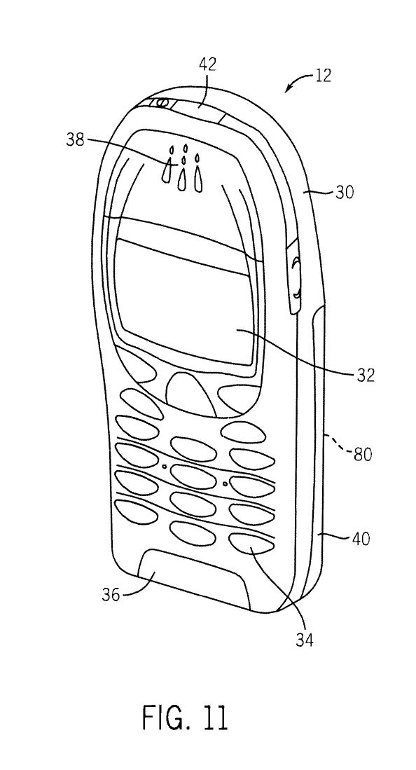

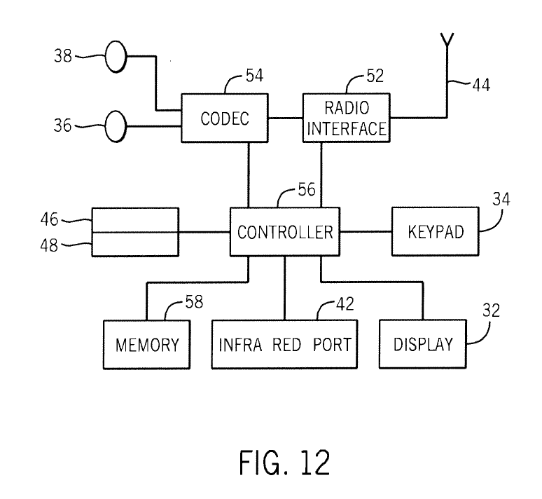

FIGS. 11 and 12 show one representative mobile telephone 12 within which the present invention may be implemented. It should be understood, however, that the present invention is not intended to be limited to one particular type of mobile telephone 12 or other electronic device. The mobile telephone 12 of FIGS. 11 and 12 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of providing video content with added media features, comprising:
providing a video content portion for transmission in a bitstream;
creating at least one supplemental enhancement information message for transmission in conjunction with the provided video content portion, the at least one supplemental enhancement information message including an indication regarding at least one of the addition, removal and replacement of visual content to the video content portion when rendered.

2. The method of claim 1, wherein the visual content is inserted into the video content portion after the video content portion has been decoded.

3. The method of claim 1, wherein the visual content is overlayed upon the video content portion after the video content portion has been decoded.

4. The method of claim 1, wherein the at least one supplemental enhancement information message includes a source ID indicator, the source ID indicator providing information concerning the tracking of multiple addition instances.

5. The method of claim 1, wherein the at least one supplemental enhancement information message includes a sequential/concurrent indicator, the sequential/concurrent indicator specifying the manner in which an addition is to occur in the bitstream.

6. The method of claim 1, wherein the at least one supplemental enhancement information message includes a source type indicator, the source type indicator specifying a type of addition for the visual content to be added to the video content portion.

7. The method of claim 1, wherein the at least one supplemental enhancement information message includes a source format indicator, the source format indicator specifying the format of the addition of the visual content.

8. The method of claim 1, wherein the at least one supplemental enhancement information message includes a rendering window width indicator, the rendering window width indicator representing the width of a window into which inserted visual media is to be rendered.

9. The method of claim 1, wherein the at least one supplemental enhancement information message includes a rendering window height indicator, the rendering window height indicator representing the height of a window into which inserted visual media is to be rendered.

10. The method of claim 1, wherein the at least one supplemental enhancement information message includes a window spatial X-axis offset indicator, the window spatial X-axis offset indicator indicating an X-axis pixel location at which an upper left-hand corner of the addition is to be rendered.

11. The method of claim 1, wherein the at least one supplemental enhancement information message includes a window spatial Y-axis offset indicator, the window spatial Y-axis offset indicator indicating an Y-axis pixel location at which an upper left-hand corner of the addition is to be rendered.

12. The method of claim 1, wherein the at least one supplemental enhancement information message includes a timestamp indicator, the timestamp indicating a rendering start time for the addition in conjunction with the video content portion.

13. The method of claim 1, wherein the at least one supplemental enhancement information message includes a duration indicator, the duration indicator representing a length of time during which the addition is to be rendered with the video content portion.

14. The method of claim 1, wherein the at least one supplemental enhancement information message includes a field indicating a location through which access to a source frame of the visual content to be added can be accessed.

15. The method of claim 14, wherein the at least one supplemental enhancement information message includes a region of interest width indicator, the region of interest width indicator representing the width of a region of interest within the source frame.

16. The method of claim 14, wherein the at least one supplemental enhancement information message includes a region of interest height indicator, the region of interest height indicator representing the height of a region of interest within the source frame.

17. The method of claim 14, wherein the at least one supplemental enhancement information message includes a region of interest spatial X-axis offset indicator, the region of interest spatial X-axis offset indicator indicating the X-axis placement of the upper left-hand corner of a region of interest within the source frame.

18. The method of claim 14, wherein the at least one supplemental enhancement information message includes a region of interest spatial Y-axis offset indicator, the region of interest spatial Y-axis offset indicator indicating the Y-axis placement of the upper left-hand corner of a region of interest within the source frame.

19. The method of claim 1, wherein the at least one supplemental enhancement information message includes a region of interest application indicator specifying a manner in which a region of interest is applied to a rendering window of the video content portion.

20. The method of claim 1, wherein the at least one supplemental enhancement information message includes a color blend type indicator specifying a color blending method to use with the visual content.

21. The method of claim 20, wherein the color blending method is selected from the group consisting of no color blending; color blending with constant alpha; color blending with per pixel alpha; alternate color blend; color blending logical AND; color blending logical OR; and color blending logical INVERT.

22. The method of claim 1, wherein the at least one supplemental enhancement information message includes a color blend constant indicator specifying that an arithmetic blending operation be performed per color channel.

23. The method of claim 1, wherein the at least one supplemental enhancement information message includes a plane blend depth indicator specifying that multiple sources of visual content be blended into a single destination.

24. The method of claim 1, wherein the at least one supplemental enhancement information message includes a plane blend alpha indicator specifying an alpha value to be used when blending sources of visual content.

25. The method of claim 1, wherein the at least one supplemental enhancement information message includes an indicator specifying how to perform a color format conversion between two sources of visual content with different color format precision.

26. The method of claim 1, wherein the at least one supplemental enhancement information message includes an indicator to specify one or more transitional effects for the visual content.

27. The method of claim 1, wherein the at least one supplemental enhancement information message includes at least one coded program segment to be added in conjunction with the video content portion.

28. A computer program, included on a computer-readable medium, for providing video content with added media features, comprising:
computer code for providing a video content portion for transmission in a bitstream; and
computer code for creating at least one supplemental enhancement information message for transmission in conjunction with the provided video content portion, the at least one supplemental enhancement information message including an indication regarding at least one of the addition, removal and replacement of visual content to the video content portion when rendered.

29. An electronic device, comprising:
a processor; and
a memory unit communicatively connected to the processor and including a computer program for providing video content with added media features, comprising:
computer code for providing a video content portion for transmission in a bitstream; and
computer code for creating at least one supplemental enhancement information message for transmission in conjunction with the provided video content portion, the at least one supplemental enhancement information message including an indication regarding at least one of the addition, removal and replacement of visual content to the video content portion when rendered.

30. A method of rendering video content with added media features, comprising:
decoding a video content portion from a bitstream;
receiving at least one supplemental enhancement information message including an indication regarding at least one of the addition, removal and replacement of visual content to the video content portion; and
rendering the decoded video content portion in conjunction with the added visual content in accordance with the at least one supplemental enhancement information message.

31. The method of claim 30, wherein the visual content is inserted into the video content portion after the video content portion has been decoded.

32. The method of claim 30, wherein the visual content is overlayed upon the video content portion after the video content portion has been decoded.

33. The method of claim 30, wherein the at least one supplemental enhancement information message includes a source ID indicator, the source ID indicator providing information concerning the tracking of multiple addition instances.

34. The method of claim 30, wherein the at least one supplemental enhancement information message includes a sequential/concurrent indicator, the sequential/concurrent indicator specifying the manner in which an addition is to occur in the bitstream.

35. The method of claim 30, wherein the at least one supplemental enhancement information message includes a source type indicator, the source type indicator specifying a type of addition for the visual content to be rendered in conjunction with the video content portion.

36. The method of claim 30, wherein the at least one supplemental enhancement information message includes a source format indicator, the source format indicator specifying the format of the addition of the visual content.

37. The method of claim 30, wherein the at least one supplemental enhancement information message includes a rendering window width indicator, the rendering window width indicator representing the width of a window into which inserted visual media is to be rendered.

38. The method of claim 30, wherein the at least one supplemental enhancement information message includes a rendering window height indicator, the rendering window height indicator representing the height of a window into which inserted visual media is to be rendered.

39. The method of claim 30, wherein the at least one supplemental enhancement information message includes a window spatial X-axis offset indicator, the window spatial X-axis offset indicator indicating an X-axis pixel location at which an upper left-hand corner of the addition is to be rendered.

40. The method of claim 30, wherein the at least one supplemental enhancement information message includes a window spatial Y-axis offset indicator, the window spatial Y-axis offset indicator indicating an Y-axis pixel location at which an upper left-hand corner of the addition is to be rendered.

41. The method of claim 30, wherein the at least one supplemental enhancement information message includes a timestamp indicator, the timestamp indicating a rendering start time for the addition in conjunction with the video content portion.

42. The method of claim 30, wherein the at least one supplemental enhancement information message includes a duration indicator, the duration indicator representing a length of time during which the addition is to be rendered in conjunction with the video content portion.

43. The method of claim 30, wherein the at least one supplemental enhancement information message includes a field indicating a location through which access to a source frame of the visual content to be added can be accessed.

44. The method of claim 43, wherein the at least one supplemental enhancement information message includes a region of interest width indicator, the region of interest width indicator representing the width of a region of interest within the source frame.

45. The method of claim 43, wherein the at least one supplemental enhancement information message includes a region of interest height indicator, the region of interest height indicator representing the height of a region of interest within the source frame.

46. The method of claim 43, wherein the at least one supplemental enhancement information message includes a region of interest spatial X-axis offset indicator, the region of interest spatial X-axis offset indicator indicating the X-axis placement of the upper left-hand corner of a region of interest within the source frame.

47. The method of claim 43, wherein the at least one supplemental enhancement information message includes a region of interest spatial Y-axis offset indicator, the region of interest spatial Y-axis offset indicator indicating the Y-axis placement of the upper left-hand corner of a region of interest within the source frame.

48. The method of claim 30, wherein the at least one supplemental enhancement information message includes a region of interest application indicator specifying a manner in which a region of interest is applied to a rendering window of the video content portion.

49. The method of claim 30, wherein the at least one supplemental enhancement information message includes a color blend type indicator specifying a color blending method to use with the visual content.

50. The method of claim 49, wherein the color blending method is selected from the group consisting of no color blending; color blending with constant alpha; color blending with per pixel alpha; alternate color blend; color blending logical AND; color blending logical OR; and color blending logical INVERT.

51. The method of claim 30, wherein the at least one supplemental enhancement information message includes a color blend constant indicator specifying that an arithmetic blending operation be performed per color channel.

52. The method of claim 30, wherein the at least one supplemental enhancement information message includes a plane blend depth indicator specifying that multiple sources of visual content be blended into a single destination.

53. The method of claim 30, wherein the at least one supplemental enhancement information message includes a plane blend alpha indicator specifying an alpha value to be used when blending sources of visual content.

54. The method of claim 30, wherein the at least one supplemental enhancement information message includes an indicator specifying how to perform a color format conversion between two sources of visual content with different color format precision.

55. The method of claim 30, wherein the at least one supplemental enhancement information message includes an indicator to specify one or more transitional effects for the visual content.

56. The method of claim 30, wherein the at least one supplemental enhancement information message includes at least one coded program segment to be added in conjunction with the video content portion.

57. A computer program product, included in a computer-readable medium, for rendering video content with added media features, comprising:
computer code for decoding a video content portion from a bitstream;
computer code for receiving at least one supplemental enhancement information message including an indication regarding at least one of the addition, removal and replacement of visual content to the video content portion; and
computer code for rendering the decoded video content portion in conjunction with the added visual content in accordance with the at least one supplemental enhancement information message.

58. An electronic device, comprising:
a processor; and
a memory unit communicatively connected to the processor and including a computer program product for rendering video content with added media features, comprising:
computer code for decoding a video content portion from a bitstream;
computer code for receiving at least one supplemental enhancement information message including an indication regarding at least one of the addition, removal and replacement of visual content to the video content portion; and
computer code for rendering the decoded video content portion in conjunction with the added visual content in accordance with the at least one supplemental enhancement information message.
